(19) United States
(12) Patent Application Publication
(10) Pub. No.: US 2018/0330869 A1
(43) Pub. Date: Nov. 15, 2018

(54) CHOKE COIL AND MANUFACTURING METHOD THEREFOR

(71) Applicant: MODA-INNOCHIPS CO., LTD., Ansan-Si, Gyeonggi-Do (KR)

(72) Inventors: Gyeong Tae KIM, Ansan-Si, Gyeonggi-Do (KR); Sang Hyun KIM, Gwangju-Si, Gyeonggi-Do (KR)

(21) Appl. No.: 15/777,627

(22) PCT Filed: Oct. 28, 2016
(86) PCT No.: PCT/KR2016/012306

§ 371 Date: May 18, 2018

(30) Foreign Application Priority Data
Nov. 18, 2015 (KR) 10-2015-0161666
Sep. 19, 2016 (KR) 10-2016-0119458

(51) Int. Cl. H01F 27/29; H01F 27/28; H01F 27/24; H01F 41/10; H01F 27/02

(52) U.S. Cl. CPC H01F 27/29; H01F 27/2823; H01F 27/02; H01F 41/10; H01F 27/24

(57) ABSTRACT

Provided is a choke coil including a core on which a flange is provided on each of both ends thereof, a terminal electrode coupled to a portion of the flange, a wire wound around the core and of which an end is withdrawn to an upper side of the terminal electrode, and a welding part provided on an upper portion of the terminal electrode. The terminal electrode includes top and bottom surfaces vertically facing each other and a side surface provided on one side between the top and bottom surfaces, and the flange has inclined areas on between first and second surfaces respectively corresponding to the top and side surfaces of the terminal electrode and between the third surface facing the second surface and the first surface.

### BACKGROUND

The present disclosure relates to a choke coil, and more particularly, to a choke coil mounted on a vehicle to secure stable characteristics and a method of manufacturing the same.

According to a related art, as a choke coil, a terminal electrode is formed on a flange of a drum core through plating or soldering, and a pair of wires are wound around the drum core to solder an end of the wire to the terminal electrode. Also, the terminal electrode formed through the plating or the soldering needs to be soldered to a wiring board of a vehicle.

When the choke coil according to the related art is mounted in the vehicle, reliability needs to be secured within a wide ranged of temperature. However, defects, in which the terminal electrode is separated from the wiring board or a crack is generated in the drum core, are generated.

Accordingly, in recent years, the choke coil is manufactured in such a manner that the terminal electrode having a [symbol] -shape is inserted into and coupled to the flange, an end of the wire is fixed by using a portion of the terminal electrode, and then a welding part is formed on an upper portion of the terminal electrode by using laser welding or arc welding.

However, whereas one portion of the terminal electrode, which is disposed on an upper portion of the wire is directly irradiated by laser and melted by laser energy to form the welding part, the other portion of the terminal electrode, which is disposed below the wire, is not directly irradiated by the laser to deprive a portion of the energy indirectly transferred to the wire, thereby reducing weldability. Also, heat generated while the welding part is formed may be transferred to the wire wound around the drum core so that the wire is disconnected or short-circuited.

Meanwhile, the terminal electrode and the core, which are connected to the wiring board, may be spaced apart from each other to secure thermal resistance due to thermal expansion difference between the core and the terminal electrode, and resultantly, the flange may be separated in a direction in which the [symbol] -shaped terminal electrode is not formed when heavy shock or vibration is generated. That is, the flange may be separated from the terminal electrode in a direction in which the flange is exposed by the [symbol] -shaped terminal electrode. Also, in case of a vehicle product, since the product frequently receives vibration and shock, high reliability is required. In addition, when a crack is generated in a fillet portion of the terminal electrode, which surrounds the core with respect to horizontal vibration of a substrate board, disconnection may occur to generate a fatal defect.

### PRIOR ART DOCUMENTS

Japanese Patent Laid-Open No. 2003-022916

### SUMMARY

The present disclosure provides a choke coil capable of improving temperature and vibration characteristics and a method of manufacturing the same.

The present disclosure also provides a choke coil capable of preventing a terminal electrode disposed below a wire from being deformed while a welding part is formed and a method of manufacturing the same.

The present disclosure also provides a choke coil capable of reducing heat transfer to a wire to prevent a wire wound around a core from being disconnected or short-circuited while a welding part is formed and a method of manufacturing the same.

In accordance with an exemplary embodiment, a choke coil include: a core on which a flange is provided on each of both ends thereof; a terminal electrode coupled to a portion of the flange; a wire wound around the core and of which an end is withdrawn to an upper side of the terminal electrode; and a welding part provided on an upper portion of the terminal electrode. The terminal electrode includes top and bottom surfaces vertically facing each other and a side surface provided on one side between the top and bottom surfaces, and the flange has inclined areas on between first and second surfaces respectively corresponding to the top and side surfaces of the terminal electrode and between the third surface facing the second surface and the first surface.

The choke coil may further include an opening defined in the top surface of the terminal electrode and above which the wire is disposed.

The opening may have a width greater than that of the wire and a length less than that of the wire seated on the top surface.

The choke coil may further include a protruding portion provided on the bottom surface of the terminal electrode and a stepped portion provided on a bottom surface of the flange. Here, the protruding portion may be engaged with the stepped portion.

The choke coil may further include an insulation layer provided on at least one area between the welding part and the terminal electrode.

The choke coil may further include first and second extension parts spaced apart from each other on the top surface of the terminal electrode. Here, the second extension part may have a shape of which an area, through which the wire passes, is recessed, and an outer side convexly protrudes.

In accordance with another exemplary embodiment, a choke coil includes: a core on which a flange is provided on each of both ends thereof; a terminal electrode coupled to a portion of the flange; first and second extension parts spaced apart from each other on one surface of the terminal electrode; a wire wound around the core and of which an end is withdrawn to an upper side of the terminal electrode; a welding part provided on the second extension part of the terminal electrode; and an insulation layer provided on at least one area between the welding part and the terminal electrode.

The choke coil may further include an opening defined in a top surface of the terminal electrode and above which the wire is disposed. Here, the opening may have a width greater than that of the wire and a length less than that of the wire seated on the top surface.

The flange may have inclined areas on between first and second surfaces respectively corresponding to the top and side surfaces of the terminal electrode and between the third surface facing the second surface and the first surface.

The second extension part may have a shape of which an area, through which the wire passes, is recessed, and an outer side convexly protrudes.

The wire may include a conductive line and an insulation sheath configured to surround the conductive line, and the insulation layer may be provided by the insulation sheath.

The choke coil may further include a protruding portion provided on a bottom surface of the terminal electrode and a stepped portion provided on a bottom surface of the flange. Here, the protruding portion may be engaged with the stepped portion.

The flange may include a first area contacting the core and a second area to which the terminal electrode is coupled, and the first area may be provided higher than the second area.

A length from the side surface to the top surface of the terminal electrode may be less than that from the side surface to the bottom surface of the terminal electrode.

The top surface of the terminal electrode may have a rectangular plate shape of which a first side is connected to the side surface, and a second side disposed on one side of the first side comes into contact between the first and second areas of the flange.

The first extension part may guide the withdrawal of the wire or temporarily fixes the wire, and the second extension part may be bent in one direction to fix the wire and form the welding part.

Each of the inclined areas may have a width of 0.05 mm to 0.25 mm.

A distance between the inclined area and the top surface of the terminal electrode may range from 0.05 mm to 0.25 mm.

In accordance with yet another exemplary embodiment, a method of manufacturing a choke coil, the method includes: coupling a terminal electrode to a flange disposed on each of both ends of a core; winding a wire to surround the core and withdrawing the wire to the outside of the terminal electrode through the terminal electrode; removing at least a portion of a sheath of the wire disposed outside the terminal electrode; and forming a welding part on an upper portion of the terminal electrode by using laser welding.

The method may further include bending the wire disposed outside the terminal electrode toward an upper side of the terminal electrode before the welding part is formed.

The wire may be withdrawn to be guided to a first extension part formed on an upper surface of the terminal electrode, and a second extension part spaced apart from the first extension part may be bent to fix the wire.

The second extension part may have a shape of which an area, through which the wire passes, is recessed, and an outer side may convexly protrude, and the second extension part may be bent so that the protruding area is deviated from a side surface of the terminal electrode.

The wire from which at least a portion of the sheath is removed, and at least a portion of the second extension part may form the welding part.

The wire from which an insulation sheath is not removed may be disposed between the welding part and the terminal electrode.

### BRIEF DESCRIPTION OF THE DRAWINGS

Exemplary embodiments can be understood in more detail from the following description taken in conjunction with the accompanying drawings, in which:

FIGS. 1 and 2 are an exploded perspective view and a coupled perspective view illustrating a choke coil in accordance with an exemplary embodiment;

FIG. 3 is an exploded perspective view illustrating the choke coil before a welding part is formed in accordance with an exemplary embodiment;

FIG. 4 is a structural view illustrating a terminal electrode of the choke coil in accordance with an exemplary embodiment;

FIGS. 5 and 6 are structural views illustrating the terminal electrode of the choke coil in accordance with modified examples of an exemplary embodiment;

FIGS. 7 and 8 are an exploded perspective view and a coupled perspective view illustrating a choke coil in accordance with another exemplary embodiment;

FIG. 9 is an exploded perspective view illustrating the choke coil before a welding part is formed in accordance with another exemplary embodiment;

FIG. 10 is a structural view illustrating a terminal electrode of the choke coil in accordance with another exemplary embodiment;

FIGS. 11 to 17 are perspective views for explaining a method of manufacturing the choke coil in accordance with an exemplary embodiment;

FIGS. 18 and 19 are an exploded perspective view and a coupled perspective view illustrating a choke coil in accordance with yet another exemplary embodiment;

FIG. 20 is an exploded perspective view illustrating the choke coil before a welding part is formed in accordance with yet another exemplary embodiment;

FIG. 21 is a structural view illustrating a terminal electrode of the choke coil in accordance with yet another exemplary embodiment;

FIGS. 22 to 27 are perspective views for explaining a method of manufacturing the choke coil in accordance with yet another exemplary embodiment; and

FIG. 28 is a view illustrating the welding part and a cross-sectional image therebelow of the choke coil in accordance with yet another exemplary embodiment.

### DETAILED DESCRIPTION OF EMBODIMENTS

Hereinafter, specific embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

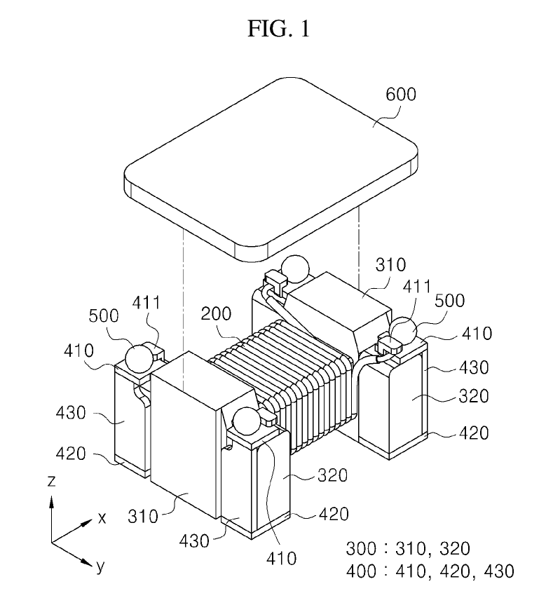

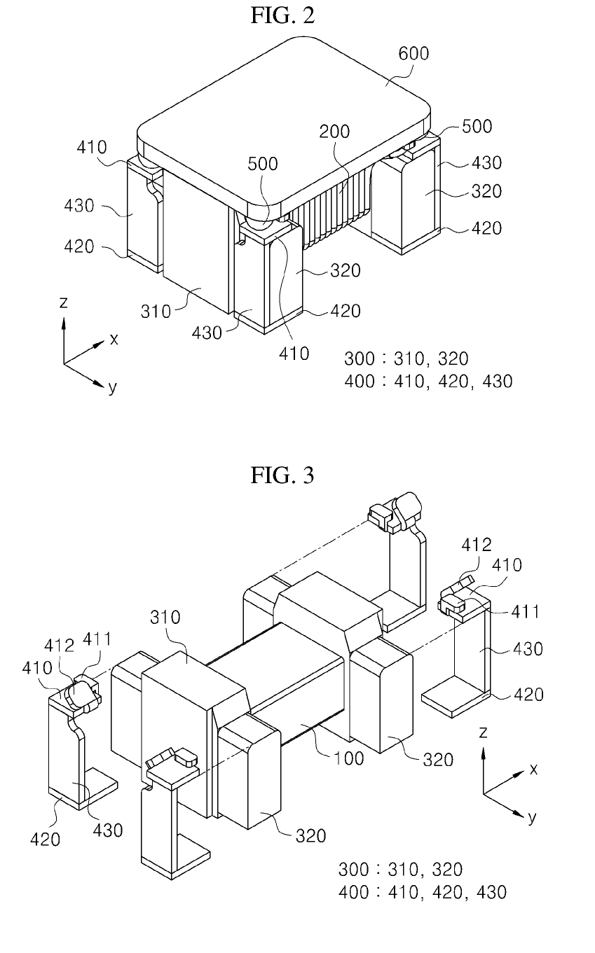

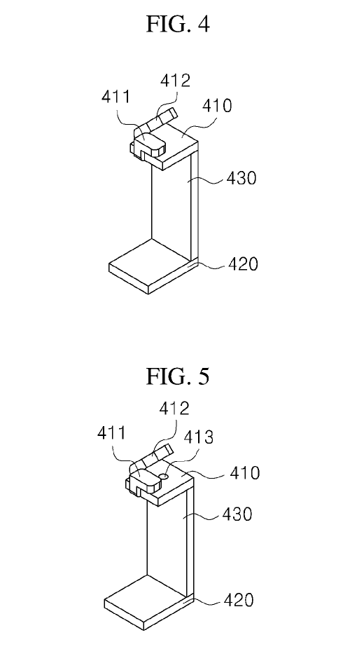

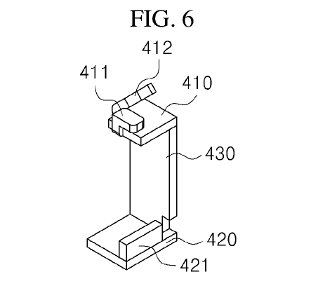

FIG. 1 is an exploded perspective view illustrating a choke coil in accordance with an exemplary embodiment, and FIG. 2 is a coupled perspective view. FIG. 3 is an exploded perspective view illustrating the choke coil before a welding part is formed in accordance with an exemplary embodiment. FIGS. 4 and 6 are structural views illustrating a terminal electrode of the choke coil in accordance with an exemplary embodiment and modified examples thereof.

Referring to FIGS. 1 to 6, in accordance with an exemplary embodiment, the choke coil for a vehicle may include a core 100, a wire 200 wound around the core 100, a flange 300 provided at each of both ends of the core 100 and of which each of both sides has a height less than that of a central portion, a terminal electrode 400 coupled to both sides of the flange 300, a welding part 500 provided on an upper portion of the terminal electrode 400, and a cover 600 provided above the core 100.

1. Core

The core 100 may have an approximately hexahedral shape, and the wire 200 may be wound to surround the core 100. For example, the core 100 may have an approximately rectangular cross-sectional shape in each of a longitudinal direction (X direction) and a width direction (Y direction), and a length in the X direction greater than that in the Y direction. That is, the core 100 may include first and second surfaces (i.e., front and rear surfaces), which face each other in the X direction, third and fourth surfaces (i.e., two side surfaces), which face each other in the Y direction, and fifth and sixth surfaces (i.e., top and bottom surfaces), which face each other in a Z direction. Here, a distance between the first and second surfaces may be greater than a width between the third and fourth surfaces. Also, the core 100 may have a corner that is rounded or has a predetermined inclination. That is, corners between the third to six surfaces (i.e., the two side surfaces and the top and bottom surfaces) may be rounded or have a predetermined inclination. As the corners of the core 100 are rounded, the wire 200 may be prevented from being cut by a sharp corner when the wire 200 is wound. Alternatively, the core 100 may have a cylindrical shape or a polyhedral shape. For example, the core 100 may have a cross-section of a plane or a polygon of a pentagon or more in the Y direction and a predetermined length in the X direction. The flange 300 may be provided on each of both ends of the core 100. That is, the flange 300 may be provided on each of the first and second surfaces in the X direction. Meanwhile, the core 100 may be made of ferrite. The ferrite material may include at least one selected from the group consisting of a nickel magnetic material (Ni Ferrite), a zinc magnetic material (Zn Ferrite), a copper magnetic material (Cu Ferrite), a manganese magnetic material (Mn Ferrite), a cobalt magnetic material (Co Ferrite), a barium magnetic material (Ba Ferrite), and a nickel-zinc-copper magnetic material (Ni—Zn—Cu Ferrite) or at least one oxide magnetic material thereof. The core 100 may be manufactured in such a manner that the ferrite material is mixed with, e.g., a polymer and then molded to have a predetermined shape such as a hexahedron.

2. Wire

The wire 200 may surround the core 100. That is, the wire 200 may surround the core 100 from one side to the other side in the X direction, e.g., in a direction from the first surface to the second surface. Also, the wire 200 may surround the core 100, and then both ends thereof may be withdrawn to an upper portion of the terminal electrode 400 coupled to the flange 300. The above-described wire 200 may be wound at least one layer around the core 100. For example, the wire 200 may include a first wire wound to contact the core 100 and a second wire wound to contact the first wire. Here, the both ends of the first wire may extend to the upper portion of the terminal electrode 400 coupled to the two flanges 300 facing each other, and the both ends of the second wire may extend to the upper portion of the terminal electrode 400, to which the first wire does not extend, coupled to the two flanges 300 facing each other. Meanwhile, the wire 200 may be made of a conductive material and covered with an insulation material to surround the wire 200. For example, the wire 200 may be a metal line made of metal such as copper to have a predetermined thickness and covered with an insulation material such as a resin. The insulation sheath may use one of polyurethane, polyesterimide, polyamideimide, and polyimide, or a mixed material in which at least two thereof are mixed or laminated. For example, the insulation sheath may use the mixed material in which polyester and polyamide are mixed or laminate the polyester and the polyamide. Meanwhile, the end of the wire 200, which contacts the upper portion of the terminal electrode 400, may expose a metal line by completely removing the insulation sheath. Laser may be irradiated at least two times to completely remove the insulation sheath. For example, the laser may be firstly irradiated to the end of the wire 200, and then the portion, to which the laser is firstly irradiated, is rotated to be secondly irradiated by the laser, thereby completely removing the insulation sheath. As the insulation sheath of the end of the wire 200 is completely removed, the insulation sheath is not disposed between the terminal electrode 400 and the wire 200.

3. Flange

The flange 300 is provided to each of the both ends of the core 100 in the X direction. The flange 300 may include a first area 310 contacting the core 100 and a second area 320 provided on both sides of the first area 310 not to contact the core 310. Each of the first and second areas 310 and 320 of the flange 300 may have a predetermined depth, a predetermined width, and a predetermined height. That is, each of the first and second areas 310 and 320 may be provided so that first and second surfaces (i.e., front and rear surfaces) facing each other in the X direction provide a predetermined depth, third and fourth surfaces (i.e., both side surfaces) facing each other in the Y direction provide a predetermined width, and fifth and sixth surfaces (i.e., bottom and top surfaces) facing each other in the X direction provide a predetermined height. In other words, in the X direction from a direction in which the terminal electrode 400 is inserted, the first surface is the front surface, and the second surface facing the first surface is the rear surface. Accordingly, the core 100 contacts the second surface, i.e., the rear surface, of the first area 310, and the second area 320 contacts the third and fourth surfaces, i.e., the both side surfaces, of the first area 310. Likewise, in the second area 320, in the X direction from a direction in which the terminal electrode 400 is inserted, the first surface is the front surface, and the second surface opposite to the first surface to face the core 100 is the rear surface. Meanwhile, the first area 310 may be provided higher than the second area 320. That is, the first and second areas 310 and 320 may be provided in such a manner that the welding part 500 is provided, and then the first area 310 contacts a bottom surface of the cover 400 and the second area 320 is provided with a height not to contact the cover 600. Here, the first area 310 may be provided with a height at which the welding part 500 does not contact the cover 600 in consideration of heights of the second area 320 and the welding part 500. Also, the first area 310 may be greater in depth and width than the second area 320. Accordingly, a stepped portion may be provided between the top surface of the first area 310 and the top surface of the second area 320, and a stepped portion may be provided between the front surface of the first area 310 and the front surface of the second area 320.

The terminal electrode 400 having a [symbol] -shape is coupled to the second area 320 of the flange 300. That is, the terminal electrode 400 is inserted from one side to the other side of the X direction and coupled to the second area 320 of the flange 300. Here, a predetermined inclination (i.e., slope) may be provided between the top surface of the second area and a surface (i.e., front surface) in a direction in which the terminal electrode 400 is coupled. That is, the second area 320 may include an inclined area having a predetermined inclination between the front and top surfaces, i.e., between the first and sixth surfaces. In other words, the predetermined inclination instead of the corner may be provided between the front and top surfaces. Here, the inclined area may be rounded to have a predetermined curvature and have a predetermined inclination from the top surface to the front surface. As the predetermined inclination is provided between the front and top surfaces as described above, the top surface of the terminal electrode 400 may move along the inclination, and thus the terminal electrode 400 may be further easily coupled.

Also, the second area 320 of the flange 300 may include a second inclined area having a predetermined depth between the rear and top surfaces (i.e., the second and sixth surfaces) in addition to the first inclined area having a predetermined depth between the front and top surfaces (i.e., the first and sixth surfaces). Here, the second inclined area may be rounded to have a predetermined curvature or have a predetermined inclination from the top surface to the rear surface. As the predetermined inclination is provided between the rear and top surfaces as described above, the wire 200 withdrawn to the terminal electrode 400 may be guided along the rounded portion to prevent the wire 200 from being disconnected or prevent the sheath from being disbanded. That is, when the corner is provided between the rear and top surfaces of the second area 320 of the flange 300, to which the wire 200 contacts to be withdrawn, the sheath of the wire 200 may be uncovered by being stabbed by the corner when the wire 200 is withdrawn. However, as the corner is processed to be rounded, the wire 200 to be withdrawn may be prevented from being disconnected.

Meanwhile, the second inclined area between the rear and top surfaces (i.e., the second and sixth surfaces) of the second area 320 may have a depth of, e.g., 0.05 mm to 0.25 mm. That is, a distance between a first virtual line extending upward from the vertical rear surface (i.e., the second surface) and a second virtual line extending upward from a boundary between the horizontal top surface (i.e., the sixth surface) and the second inclined area may be, e.g., 0.05 mm to 0.25 mm. Also, a distance between the boundary between the horizontal top surface (i.e., the sixth surface) and the second inclined area and an outer side (a second side that will be described later) of the top surface 410 of the terminal electrode 400 may be, e.g., 0.05 mm to 0.25 mm. That is, a distance between the boundary between the top surface and the second inclined area of the second area 320 of the flange 300 and the outer side (i.e., the second side) of the top surface 410 of the terminal electrode 400 may be, e.g., 0.05 mm to 0.25 mm. Here, when a distance between the outer side of the top surface 410 of the terminal electrode 400 and the boundary area increases over 0.25 mm, a size of the top surface 410 of the terminal electrode 400 may decrease and, accordingly, a size of the welding part 500 may be limited. Thus, the distance is desirable to maintained equal to or below than 0.25 mm. Also, when the distance between the outer side of the top surface 410 of the terminal electrode 400 and the boundary area is lower than 0.05 mm or the top surface 410 covers the second inclined area, the withdrawn wire 200 may be stabbed by the corner of the second side of the top surface 410 so that the wire 200 is disconnected or the sheath is uncovered. When the distance between the outer side of the top surface 410 of the terminal electrode 400 and the boundary area is greater than 0.25 mm, the size of the top surface 410 of the terminal electrode 400 may decrease, and accordingly, the size of the welding part 500 provided on the top surface 410 may be limited. Thus, the distance equal to or greater than 0.05 mm is desirable.

Also, a bending angle of the wire 200 may be adjusted according to a depth of the second inclined area 320, a depth of the stepped portion, and a thickness of the top surface 410 of the terminal electrode 400. For example, when the thickness of the top surface 410 of the terminal electrode 400 is 0.1 mm and the depths of the second inclined area and the stepped portion are 0.05 mm, 0.1 mm, 0.15 mm, 0.2 mm, and 0.25 mm, bending angles of the wire 200 may be 40°, 37°, 34°, 32°, and 31°. Also, when the thickness of the top surface 410 of the terminal electrode 400 is 0.15 mm and the depths of the second inclined area and the stepped portion are 0.05 mm, 0.1 mm, 0.15 mm, 0.2 mm, and 0.25 mm, the bending angles of the wire 200 may be 42°, 37°, 35°, 34°, and 31°. The bending angle of the wire 200 to be withdrawn may range from 31° to 42° with respect to the top surface of the second area 320, and be less than 31° when the top surface 410 of the terminal electrode 400 is deviated from a tangent line of the rounded area. When the bending angle is greater than the above-described range, the withdrawn wire 200 may be difficult to be guided by the first extension part 412 of the terminal electrode 400.

4. Terminal Electrode

The terminal electrode 400 is coupled to the second area 320 of the flange 300, and the wire 200 is fixed to an upper portion thereof to provide the welding part 500. The terminal electrode 400 may have an approximately [symbol] -shape so that the terminal electrode 400 is inserted and coupled to the flange 300. That is, the terminal electrode 400 includes a top surface 410, a bottom surface 420, and a side surface 430 connecting the top surface 410 to the bottom surface 420. Accordingly, the top surface 410, the bottom surface 420, and the side surface 430 may provide the approximately [symbol] -shape. Here, the top surface 410 may have an approximately rectangular plate shape. That is, the top surface 410 may include a first side contacting the side surface 430, a second side facing the first side, a third side contacting a stepped portion between the first and second areas 310 and 320 of the flange 300 between the first and second sides, and a fourth side facing the third side. Also, the bottom surface 420 may have an approximately rectangular plate shape having first to fourth sides respectively corresponding to the first to forth sides of the top surface 410, and the side surface 430 may have an approximately rectangular plate shape having a height corresponding to a distance between the top surface 410 and the bottom surface 420. The above-described terminal electrode 400 is coupled to the flange 300 in such a manner that the terminal electrode 400 is inserted from an opened area facing the side surface 430 to the second area 320 of the flange 300, and the top surface 410 and the bottom surface 420 respectively contact the upper and bottom surfaces of the second area 320 of the flange 300 and the side surface 430 contacts the front surface of the second area 320. Here, as the predetermined inclination is provided between top and front surfaces of the second area 320 of the flange 300, the top surface 410 of the terminal electrode 400 may move to the top surface of the flange 300 along the inclined surface. Also, the side surface of the terminal electrode 400 may be perpendicular to the top surface 410 and the bottom surface 420. However, each of angles between the side surface 420 and each of the upper and bottom surfaces 410 and 420 of the terminal electrode 400 may have an acute angel less than 90°, e.g., approximately 88°, to increase coupling force by using pressing force of one of the top surface 410 and the bottom surface 420.

Meanwhile, the bottom surface 420 of the terminal electrode 400 may be greater in size than the top surface 410 thereof. The bottom surface 420 may cover an entire bottom surface of the second area 320 of the flange 300, and the top surface 410 may cover a portion of the top surface of the second area 320. That is, the second area 320 of the flange 300 includes the rounded second inclined area provided between the rear and top surfaces, and thus, the top surfaced 410 of the terminal electrode 400 may be provided until the boundary between the top surface and the second inclined area or provided less than that. When the top surface 410 is provided greater than the second inclined area, since a space is provided between the top surface 410 and the second inclined area, and the wire 200 is withdrawn along one surface of the top surface 410, the sheath of the wire 200 may be uncovered, or the wire 200 may be disconnected by the corner of the top surface 410.

Also, first and second extension parts 411 and 412 may be provided to fix an end of the wire 200 to the top surface 410 of the terminal electrode 400. The first extension part 411 temporarily fixes the end of the wire 200, and the second extension part 412 fixes the end of the wire 200 to provide the welding part 500 with the wire 200. That is, a portion of the wire 200 and the second extension part 412 may be melted to provide the welding part 500.

The first extension part 411 may be provided on one side facing the other side of the top surface 410 contacting the side surface 430 of the terminal electrode 400. That is, the first extension part 411 may be provided on the second side facing the first side contacting the side surface 430 of the top surface 410. Also, the first extension part 411 may be provided adjacent to the stepped portion between the first and second areas 310 and 320 of the flange 300. That is, the first extension part 411 may have a predetermined width from the corner area between the second and third sides to the third side. The above-described first extension part 411 may extend a predetermine height from the third side and then extend in one direction again. That is, the first extension part 411 may include a height portion having a predetermined height from the top surface 410 and a horizontal portion extending from the end of the height portion to a direction opposite to the first area 310 of the flange 300, i.e., a direction toward the fourth side of the top surface 410. Accordingly, the first extension part 411 may have, e.g., a [symbol] -shape in a direction toward the fourth side. Since the first extension part 411 is provided adjacent to the stepped portion of the flange 300, the wire 200 may be guided to be withdrawn by the height portion and the horizontal portion of the first extension part 411. That is, since the wire 200 is guided between the height portion and the horizontal portion of the first extension part 411 having a [symbol] -shape, the wire 200 may be prevented from being separated. Also, the first extension part 411 may be bent in a withdrawal direction of the wire 200, i.e., a direction opposite to the core 100. Accordingly, the horizontal portion of the first extension part 411 may contact the top surface 410 in a direction perpendicular to the withdrawal direction of the wire 200, i.e., a direction between the third and fourth sides, so that the horizontal portion temporarily fixes the wire 200.

The second extension part 412 may be spaced apart from the first extension part 411. For example, the second extension part 412 may be provided on the third side of the top surface 410 of the terminal electrode 400 contacting the stepped portion of the flange 300. That is, the second extension part 412 may include a height portion provided with a predetermined height on a predetermined area of the third side and a horizontal portion provided with a predetermined size from an end of the height portion. Here, the horizontal portion may have a depth greater than that of the height portion. That is, the horizontal portion of the second extension part 412 may be provided greater in size than the first extension part 411 in consideration of a size of the welding part 500. For example, the horizontal portion of the second extension part 412 may be widened in a direction from the height portion to the first side. Also, the second extension part 412 may be bent in a direction perpendicular to a bending direction of the first extension part 411. That is, the height portion of the first extension part 411 is bent in a direction from the second side to the first side of the top surface 410, and the second extension part 412 is bent in a direction from the third side to the fourth side of the top surface 410. Accordingly, the horizontal portion of the first extension part 411 and the horizontal portion of the second extension part 412 fix the wire 200 in the same direction as each other. As described above, the wire 200 may contact and be fixed onto the top surface 410 of the terminal electrode 400 by the first and second extension parts 411 and 412.

Meanwhile, as illustrated in FIG. 5, an opening 413 may be defined in the top surface 410 of the terminal electrode 400. The opening 413 may be defined with a predetermined width and a predetermined length, and the wire 200 may be disposed thereabove. That is, as the opening 413 is defined, the top surface of the second area 320 of the flange 300 may be exposed below the wire 200. Here, the opening 413 may be greater in width than the wire 200 and less in length than the wire seated on the top surface 410. Accordingly, the wire 200 may float above the opening 413, and the end of the wire 200 may contact the top surface 410 of the terminal electrode 400. That is, the wire 200 may contact the top surface 410 of the terminal electrode 400 with a predetermined width from the end of the wire 200, and a portion of the wire 200 may float above the opening 413. Surely, a portion of the wire may contact on the flange 300 through the opening 413. As described above, the wire 200 and the second extension part 412 may be disposed above the opening 413, and the wire 200 and the second extension part 412 may be melted by laser irradiation to provide the welding part 500. That is, the welding part 500 may be disposed above the opening 413. As the opening 413 is defined in the top surface 410 of the terminal electrode 400, when the laser is irradiated to form the welding part 500, energy due to the laser may be prevented from being conducted to the top surface 410 of the terminal electrode 400 through the wire 200. Accordingly, the top surface 410 of the terminal electrode 400 may be prevented from being deformed by heat generated while the laser is irradiated, and the welding part 500 may be formed by using the optimized energy. Also, the thermal energy conducted to the wound wire 200 may decrease to prevent the disconnection. Also, an air layer caused by the opening 413 may be provided between the welding part 500 and the flange 300 to generate a fast cooling effect after the welding part 500 is formed and stably maintain a shape of the welding part 500.

Also, as a portion of the welding part 500 formed while the second extension part 412 of the terminal electrode 400 and the wire 200 is welded is disposed on the opening 413 of the terminal electrode 400, a height of the welding part 500 after the welding may decrease. Accordingly, since a height space area of the welding part 500 in the Z direction is maximally used, a product may be designed to be miniaturized and low-profiled.

Also, as illustrated in FIG. 6, a stepped portion 330 may be provided on the bottom surface of the second area 320 of the flange 300. That is, the stepped portion 330 may be provided between the one side surface, which does not contact the first area 310, and the bottom surface of the second area 320. For example, the stepped portion 330 may be provided by removing a portion of one side surface of the second area 320. Here, the stepped portion 330 between the side surface and the bottom surface of the second area 320 may have a right angle or a predetermined inclination. A protruding portion 421 protruding upward from an edge of the bottom surface 420 of the terminal electrode 400 may be provided in correspondence with the stepped portion 330. The protruding portion 421 may be provided to have a height corresponding to that of the stepped portion provided on the bottom surface of the second area 320 of the flange 300. As described above, as the stepped portion 330 is provided on the bottom surface of the second area 320, and the terminal electrode 400 is provided on a lower portion of the terminal electrode 400 to corresponding to the stepped portion 330, the protruding portion 421 is closely fixed to the stepped portion 330 and coupled to the terminal electrode 400 to further firmly couple the terminal electrode 400 to the flange 300. That is, when the protruding portion 421 is not provided, the flange 300 may not be separated from the terminal electrode 400 by the side surface, the top surface 410, and the bottom surface 420 of the terminal electrode 400 with respect to vibration in the X and Z directions, however, the flange 300 may be separated from the terminal electrode 400 by vibration in the Y direction. As the protruding portion 421 contacts the flange 300 in addition to the top surface 410, the bottom surface 420, and the side surface 430 of the terminal electrode 400, a contact surface between the terminal electrode 400 and the flange 300 may increase. Accordingly, the terminal electrode 400 may be further strongly coupled to prevent the terminal electrode 400 and the flange 300 from being separated by the vibration in the X, Y, and Z directions. Also, as the protruding portion 421 is provided, when the product is mounted, two fillets may be provided in the X and Y directions to prevent the core 100 coupled to the terminal electrode 400 mounted on the board and the product from being separated when the vibration or strong shock is generated on the board. Also, as the two fillets of the terminal electrode 400 are provided, although crack is generated on a terminal surface in one direction and a surface between solder fillets, the terminal surface and the solder fillet in a cross direction may be maintained to prevent disconnection on the product and realize stable performance, thereby securing high reliability.

5. Welding Part

The welding part 500 is provided on the upper portion of the terminal electrode coupled to the second area 320 of the flange 300. The welding part 500 may be formed in such a manner that laser is irradiated to the second extension part 412 in a state in which the first and second extension parts 411 and 412 are fixed on the terminal electrode 400. That is, the wire 200 and the second extension part 412 may be melted to form the welding part 500. Also, the welding part 500 may have a spherical shape. The above-described welding part 500 may be formed to have a height less than that of the first area, and thus, the welding part 500 may not contact the cover 600.

6. Cover

The cover 600 may be provided above the core 100 around which the wire 200 is wound and to which the terminal electrode 400 is coupled. The cover 600 may have an approximately rectangular plate shape having a predetermined thickness. Here, the cover 600 may have a bottom surface contacting the upper portion of the first area 310 and be spaced apart from the welding part 500. Surely, the welding part 500 may have various shapes so that one area thereof is spaced apart from the welding part 500. For example, the first area 310 of the flange 300 and the welding part 500 may have the same height as each other, and a protruding portion protruding from a central portion of a bottom surface of the cover 600 may contact the upper portion of the first area 310, so that the cover 600 does not contact the welding part 500. Also, the cover 600 may include a recessed portion in an outer side of a central portion thereof in the Y direction, e.g., a portion corresponding to the second area 320 of the flange 300.

As described above, in the choke coil in accordance with an exemplary embodiment, the flange 300 is provided on each of the both ends of the core 100 around which the wire 200 is wound, and the terminal electrode 400 having a [symbol] -shape is coupled to the second area 320 of the flange 300. Also, as the inclined surface (or, the rounded surface) is formed between the top, front, and rear surfaces of the second area 320 of the flange 300, the terminal electrode 400 may be easily coupled, and the wire to be withdrawn to the top surface 410 of the terminal electrode 400 may be prevented from being disconnected. As the opening 413 is defined in the top surface 410 of the terminal electrode 400, when the laser is irradiated to form the welding part 500, the energy caused by the laser may be prevented from being conducted to the top surface 410 of the terminal electrode 400 through the wire 200. Accordingly, the top surface 410 of the terminal electrode 400 may be prevented from being deformed by the heat generated while the laser is irradiated, the welding part 500 may be formed by using the optimized energy, and the thermal energy conducted to the wound wire 200 may be reduced to prevent the disconnection.

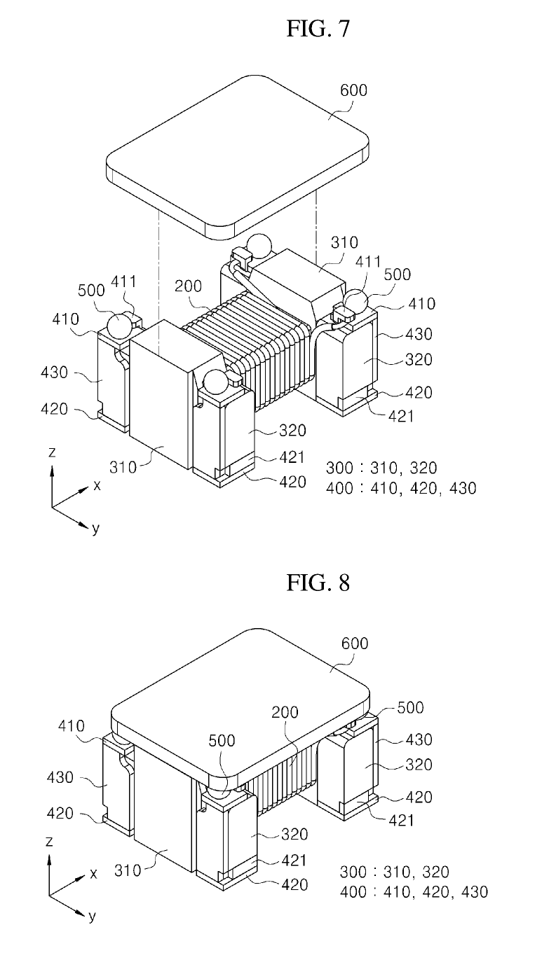

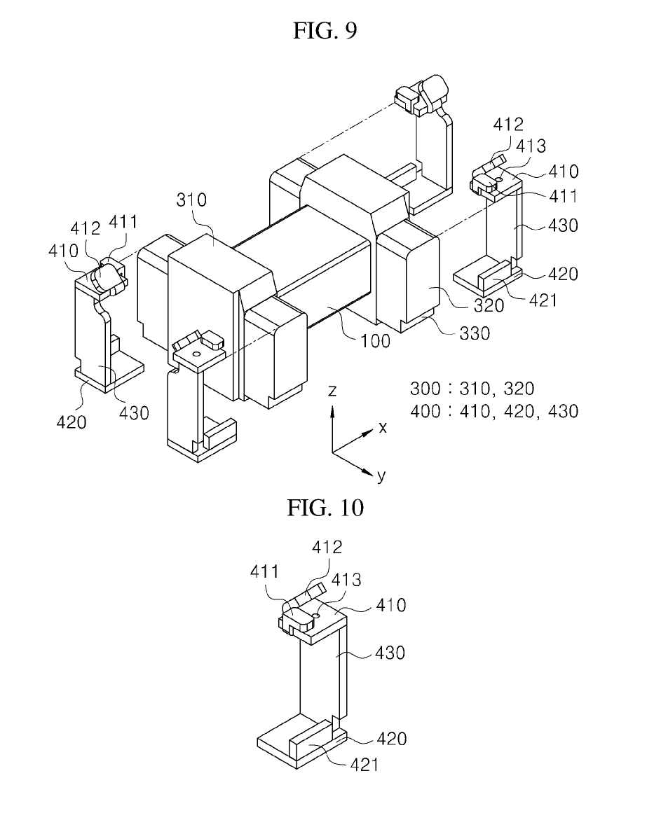

FIG. 7 is an exploded perspective view illustrating a choke coil in accordance with another exemplary embodiment, and FIG. 8 is a coupled perspective view. FIG. 9 is an exploded perspective view illustrating the choke coil before a welding part is formed in accordance with another exemplary embodiment. FIG. 10 a structural view illustrating a terminal electrode of the choke coil in accordance with another exemplary embodiment.

Referring to FIGS. 7 to 10, in accordance with another exemplary embodiment, the choke coil for a vehicle may include a core 100, a wire 200 wound around the core 100, a flange 300 including a first area 310 provided on each of both ends of the core 100 to contact the core 100 and a second area 320 provided on each of both sides of the first area 320 to have a height less than that of the first area 320, a terminal electrode 400 coupled to each of both sides of the flange 300 and including a protruding portion 421 corresponding to a stepped portion 330, a welding part 500 provided on the terminal electrode 400, and a cover 600 provided above the core 100. The choke coil for a vehicle may further include the stepped portion 330 provided on a lower portion of the second area 320. That is, in accordance with another exemplary embodiment, an opening 413 may be defined in a top surface 410 of the terminal electrode 400, the stepped portion 330 may be provided on the lower portion of the second area 320, and the protruding portion 421 may be provided on the bottom surface 420 corresponding to the stepped portion 330 of the terminal electrode 400.

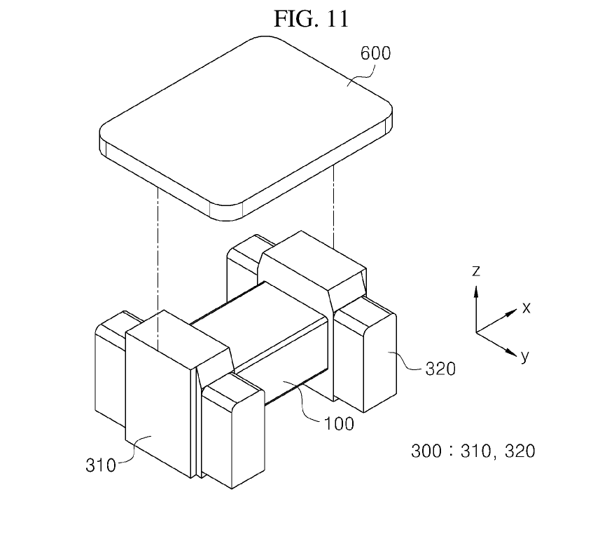

FIGS. 11 to 17 are perspective views for explaining a method for manufacturing the choke coil in accordance with an exemplary embodiment.

Referring to FIG. 11, the core 100 in which the flange 300 is coupled to the both ends thereof and the cover 600 is separately manufactured. The core 100 may have an approximately rectangular cross-sectional shape in each of the longitudinal direction (X direction) and the width direction (Y direction) and have a largely approximately hexahedral shape having a size that is greater in the X direction than in the Y direction. Also, the core 100 may have the corner that is rounded or has a predetermined inclination. The flange 300 may be provided to each of the both ends of the core 100 in the X direction. The flange may be integrated with the core 100 or separately manufactured and then coupled to the core 100. The flange 300 may include the first area 310 contacting the core 100 and the second area 320 formed on both sides of the first area 310 not to contact the core 310. Here, the first area 310 may be formed higher than the second area 320. Also, the predetermined inclined surface or the rounded surface may be formed between the top surface of the second area 320 and a surface (i.e., front surface) to which the terminal electrode 400 is coupled and between the top surface and the rear surface. Meanwhile, the cover 600 may have an approximately rectangular plate shape having a predetermined thickness.

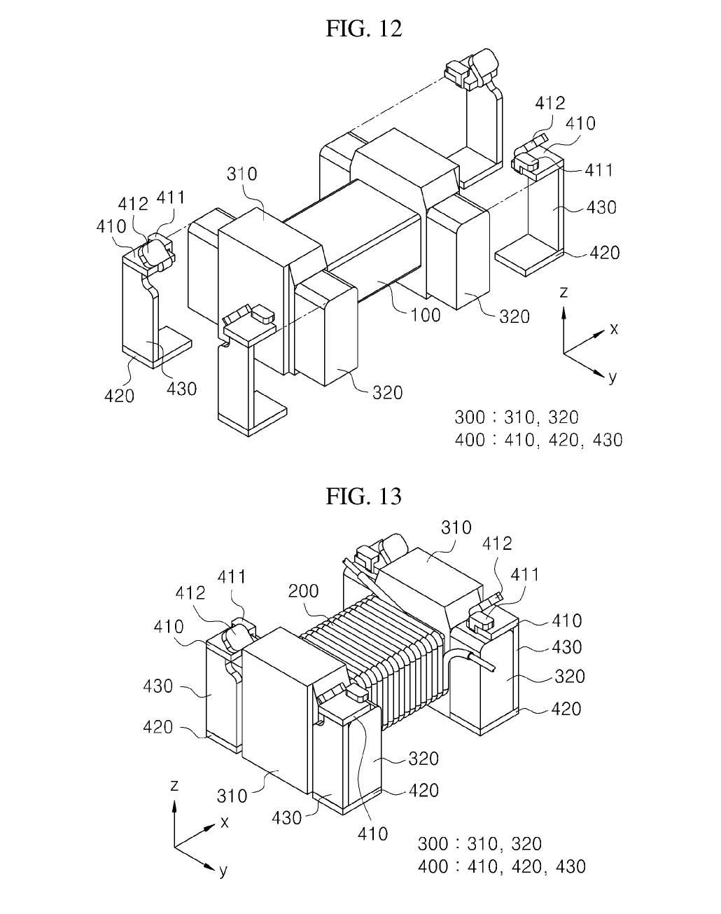

Referring to FIG. 12, the terminal electrode 400 is inserted into the second area 320 of the flange 300 to couple the terminal electrode 400 to the flange 300. For this, the terminal electrode 400 may have the approximate [symbol] -shape. That is, the terminal electrode 400 may include the top surface 410 and the bottom surface 420, which face each other in the Z direction, and the side surface provided therebetween to form the approximate [symbol] -shape. Also, the protruding portion (not shown) protruding upward from the edge of the bottom surface 420 of the terminal electrode 400 may be formed. Corresponding to the protruding portion, the predetermined stepped portion (not shown) may be formed on the bottom surface of the second area 320 of the flange 320. That is, the stepped portion may be formed between one side surface that does not contact the first area 310 and the bottom surface of the second area 320. Here, the protruding portion of the terminal electrode 400 may have a height corresponding to the stepped portion formed on the bottom surface of the second area 320. The above-described terminal electrode 400 is coupled to the flange 300 in such a manner that the terminal electrode 400 is inserted from the opened area facing the side surface 430 to the second area 320 of the flange 300, and the top surface 410 and the bottom surface 420 respectively contact the top and bottom surfaces of the second area 320 of the flange 300, and the side surface 430 contacts the front surface of the second area 320. Here, as the predetermined inclination is formed between the top and front surfaces of the second area 320 of the flange 300, the top surface 410 of the terminal electrode 400 may move to the top surface of the flange 300 along the inclined surface. Also, the protruding portion provided on the lower portion of the terminal electrode 400 may closely contact the stepped portion formed on the bottom surface of the second area 320 to couple the terminal electrode 400 to the flange 300. As the protruding portion contacts the flange 300 in addition to the side, upper, and bottom surfaces of the terminal electrode 400, the contact surface between the terminal electrode 400 and the flange 300 may increase, and, accordingly, the terminal electrode 400 may be further strongly coupled. Meanwhile, the opening 413 may be formed in the top surface 410 of the terminal electrode 400.

Referring to FIG. 13, the wire 200 is wound to surround the core 100. That is, the wire 200 may surround the core 100 from one side to the other side of the core 100 in the X direction. The above-described wire 200 may include the first wire wound to contact the core 100 and the second wire wound to contact the first wire. Both ends of the first wire may extend to the upper portion of the terminal electrode 400 coupled to the two flanges 300 facing each other, and both ends of the second wire may extend to the upper portion, to which the first wire does not extend, of the terminal electrode 400 coupled to the two flanges 300 facing each other. Meanwhile, the wire 200 may be made of a conductive material and covered with an insulation material to surround the wire 200. For example, the wire 200 may be made of metal such as copper to have a predetermined thickness and covered with an insulation material such as a resin. The wire 200 is wound, and then a sheath of the end of the wire 200 is uncovered. The sheath of the end of the wire 200, which covers the metal line, may be completely removed to be uncovered. For this, the laser may be provided above the wire 200 and irradiated to the upper side of the wire 200. Thereafter, the wire 200 may rotate toward an area to which the laser is not irradiated, and then the laser may be irradiated again.

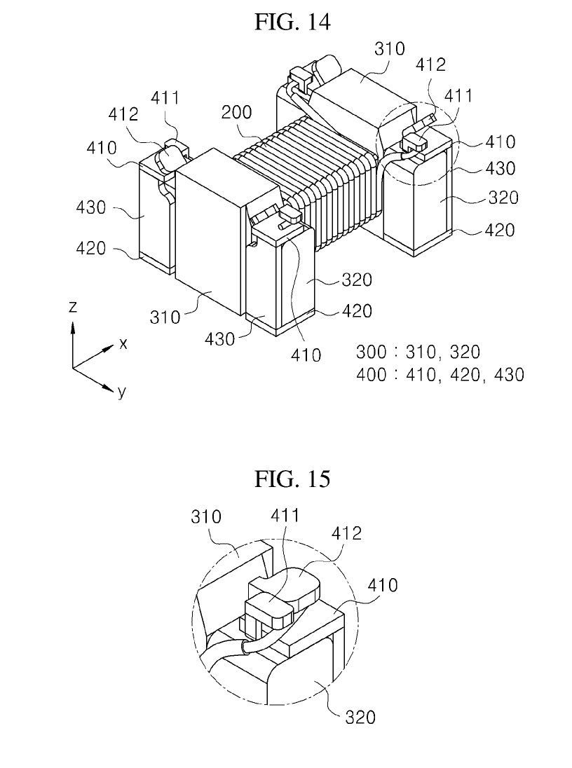

Referring to FIGS. 14 and 15, the end of the wire 200, i.e., the end, from which the sheath is removed, of the wire 200 is withdrawn to the upper portion of the terminal electrode 400. Here, since the portions between the top surface and each of the front and rear surfaces of the second area 320 of the flange 300 are rounded, the wire 200 is withdrawn to the top surface 410 of the terminal electrode 400 along the rounded area. Also, since the top surface 410 of the terminal electrode 400 includes the height portion and the horizontal portion to form the first extension part 411 having an approximately [symbol] -shape, the wire 200 is guided between the height portion and the horizontal portion and disposed on the top surface 410 of the terminal electrode 400. Here, the wire 200 is seated on the opening 413. Accordingly, a portion of the wire 200 is disposed on the opening 413. Meanwhile, when the opening is formed in the top surface 410 of the terminal electrode 400, the wire 200 is withdrawn to pass above the opening. As described above, the wire 200 is seated, and then the first extension part 411 is bent to temporarily fix the wire 200. Thereafter, the second extension part 412 is bent to fix the wire 200.

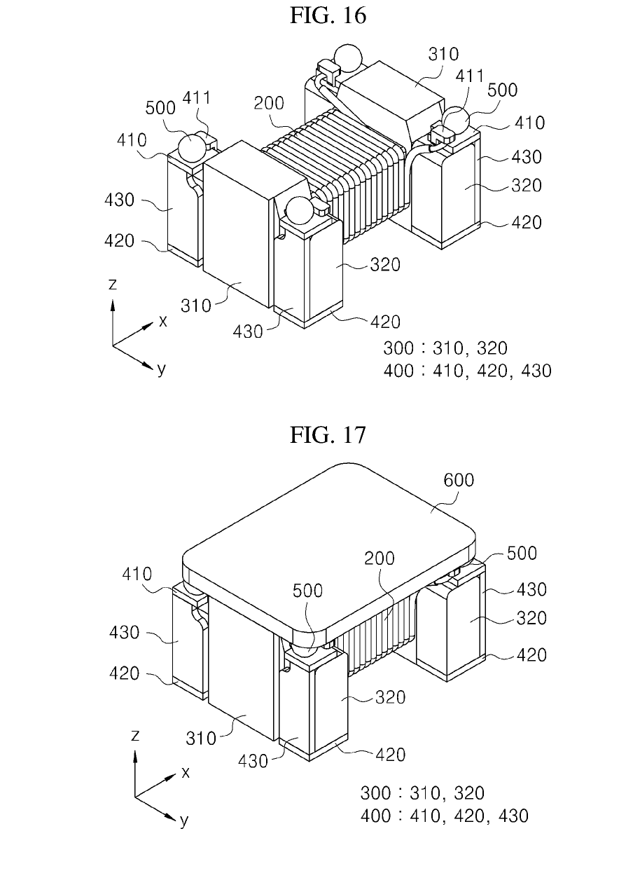

Referring to FIG. 16, the laser is irradiated toward the second extension part 412 to form the welding part 500. That is, the second extension part 412 and the wire 200 are melted by the laser irradiation to form the welding part 500 having a spherical shape on the top surface 410 of the terminal electrode 400. Here, when the opening is formed in the top surface 410 of the terminal electrode 400, the welding part 500 may be formed above the opening. As the opening 413 is formed in the top surface 410 of the terminal electrode 400, the energy caused by the laser irradiated to form the welding part 500 may be prevented from being conducted to the top surface 410 of the terminal electrode 400 through the wire 200. Accordingly, the top surface 410 of the terminal electrode 400 may be prevented from being deformed by the heat generated while the laser is irradiated, and the welding part 500 may be formed by using the optimized energy. Also, the thermal energy conducted to the wound wire 200 may be reduced to prevent the disconnection. Also, the air layer formed by the opening 413 may be formed between the welding part 500 and the flange 300 to generate a fast cooling effect after the welding part 500 is formed, and stably maintain the shape of the welding part 500.

Referring to FIG. 17, the cover 600 is covered to contact the upper portion of the first area 310 of the flange 300.

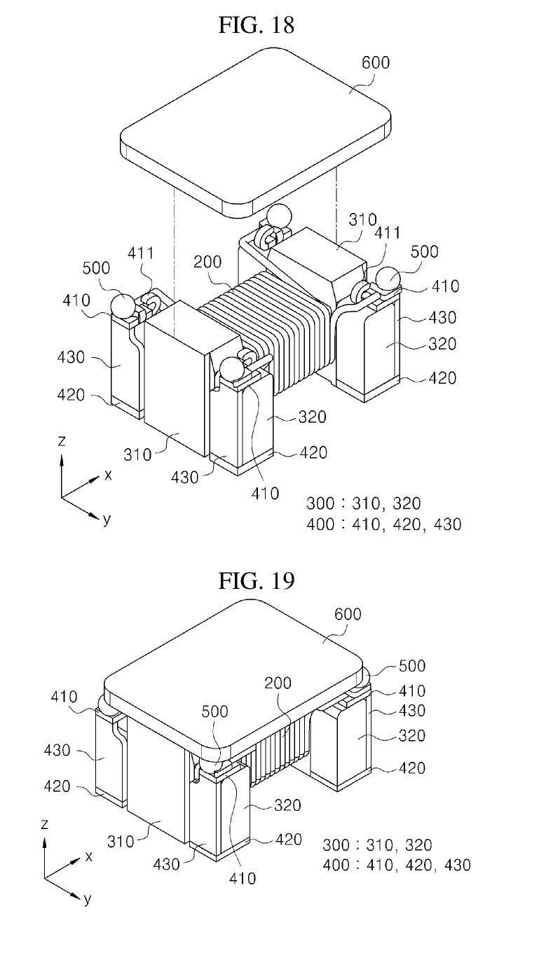

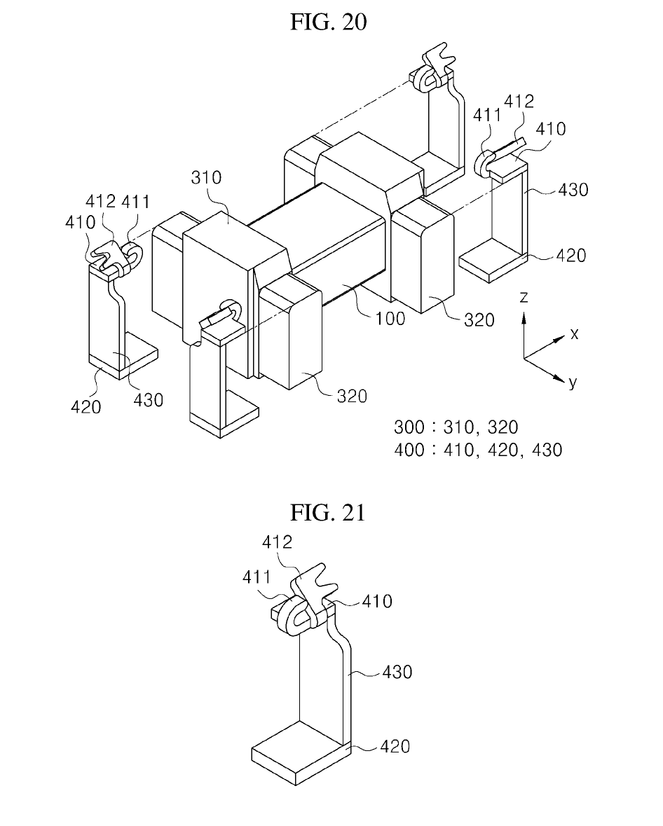

FIG. 18 is an exploded perspective view of a choke coil in accordance with yet another exemplary embodiment, and FIG. 19 is a coupled perspective view. FIG. 20 is an exploded perspective view of the choke coil before a welding part is formed in accordance with yet another exemplary embodiment, and FIG. 21 is a structural view of the terminal electrode.

Referring to FIGS. 18 and 21, in accordance with yet another exemplary embodiment, the choke coil may include a core 100, a wire 200 wound around the core 100, a flange 300 formed on each of both ends of the core 100 to have both sides each of which has a height less than that of a central portion, a terminal electrode 400 coupled to each of both sides of the flanges 300, a welding part 500 formed on an upper portion of the terminal electrode 400, and a cover 600 provided above the core 100. Here, in accordance with yet another exemplary embodiment, a configuration including the core 100, the wire 200, and the flange 300 is the same, and shapes of the terminal electrode 400 and the welding part 500 are different. Accordingly, contents in accordance with yet another exemplary embodiment, which are different from those in accordance with an exemplary embodiment and another exemplary embodiment, will be mainly described as follows.

The core 100 may has an approximately hexahedral shape, and the wire 200 may be wound to surround the core 100. For example, the core 100 may include first and second surfaces (i.e., front and rear surfaces), which face each other in the X direction, third and fourth surfaces (i.e., two side surfaces), which face each other in the Y direction, and fifth and sixth surfaces (i.e., top and bottom surfaces), which face each other in the Z direction. Here, a distance between the first and second surfaces is greater than a width between the third and fourth surfaces. Also, the core 100 may have a corner that is rounded or has a predetermined inclination. That is, each of corners between the third to six surfaces (i.e., between two side surfaces and the top and bottom surfaces) may be rounded or have a predetermined inclination. The flange 300 may be provided on each of both ends of the core 100, i.e., the first and second surfaces in the X direction.

The wire 200 may be provided to surround the core 100. Also, the wire 200 may surround the core 100, and then an end thereof may be withdrawn to the upper portion of the terminal electrode 400 coupled to the flange 300. Meanwhile, during manufacturing, the wire 200 may pass to be withdrawn above the terminal electrode 400 and the end thereof may be disposed outside the terminal electrode 400. That is, before the welding part 500 is formed, the wire 200 may be disposed a predetermined distance inside from the end thereof on the terminal electrode 400 and withdrawn a predetermine distance from the position to the end may be disposed outside the terminal electrode 400. Meanwhile, the wire 200 may be made of a conductive material and covered with an insulation material to surround the wire 200. However, in the choke coil in accordance with yet another exemplary embodiment, the insulation material is not removed from an area in which the wire 200 contacts the upper portion of the terminal electrode 400, and the insulation material of the end disposed outside the terminal electrode 400 may be removed. That is, the laser may be irradiated at least one time on the end of the wire 200 disposed outside the terminal electrode 400 before the welding part 500 is formed to remove at least a portion of the sheath. That is, the laser may be irradiated from the upper side to the end of the wire 200 disposed outside the terminal electrode 400 to remove the upper side sheath and allow the lower side sheath to remain, and the laser may be irradiated to each of the upper and lower sides to completely remove the sheath of the end of the wire 200. Surely, the laser may be irradiated from below the wire 200 to remove the lower side sheath of the end of the wire 200 and allow the upper side sheath to remain. As a result, in accordance with yet another exemplary embodiment, at least a portion of the insulation sheath may be removed from the end disposed outside the terminal electrode 400 from the withdrawn direction of the wire 200 according to the laser irradiation method. As described above, as the insulation sheath of the wire 200 disposed on the terminal electrode 400 is not removed, and a portion of the insulation sheath of the end of the wire 200 disposed outside the terminal electrode 400 is removed, when the welding part 500 is formed, the insulation layer may exist between the wire 200 and the terminal electrode 400 by the insulation sheath of the wire 200. Also, the insulation layer may remain on at least one area of the welding part 500 in addition to other areas. That is, in accordance with yet another exemplary embodiment, as the wire 200 and the terminal electrode 400 exist below the welding part 500, the insulation layer may remain between the welding part 500 and the wire 200 and between the wire 200 and the terminal electrode 400. Also, the insulation layer may remain on a surface of the welding part 500 or the like. As a result, in accordance with yet another exemplary embodiment, the insulation layer may exist on a plurality of areas around the welding part 500. That is, since the welding part 500 is formed in a state in which the insulation sheath of the wire 200 between the welding part 500 and the terminal electrode 400 is not removed and the insulation sheath of the wire 200 disposed outside the terminal electrode 400 is removed, the insulation layer may exist on the plurality of areas around the welding part 500.

The flange 300 is provided on each of the both ends of the core 100 in the X direction. The flange 300 may include a first area 310 contacting the core 100 and a second area 320 provided on each of both sides of the first area 310 not to contact the core 310. In the above-described flange 300, each of the first and second areas may be provided so that first and second surfaces (i.e., front and rear surfaces), which face each other in the X direction, provide a predetermined depth, third and fourth surfaces (i.e., two side surfaces), which face each other in the Y direction, provide a predetermined width, and fifth and sixth surfaces (i.e., top and bottom surfaces), which face each other in the Z direction, provide a predetermined height. The terminal electrode 400 having a [symbol] -shape is coupled to the second area 320 of the flange 300.

The terminal electrode 400 is inserted to be coupled to the second area 320 of the flange 300, and the wire 200 is seated on the upper portion thereof to provide the welding part 500. The above-described terminal electrode 400 may have an approximately [symbol] -shape so that the terminal electrode 400 is inserted and coupled to the flange 300. That is, the terminal electrode 400 includes the top surface 410 and the bottom surface 420, which are vertically spaced apart from each other, and the side surface 430 connecting the top surface 410 to the bottom surface 420. Accordingly, the top surface 410, the bottom surface 420, and the side surface 430 may provide the approximately [symbol] -shape. Here, the top surface 410 may have an approximately rectangular plate shape. That is, the top surface 410 may include a first side contacting the side surface 430, a second side facing the first side, a third side contacting a stepped portion between the first and second areas 310 and 320 of the flange 300 between the first and second sides, and a fourth side facing the third side. Also, the bottom surface 420 may have an approximately rectangular plate having first to fourth sides respectively corresponding to the first to forth sides of the top surface 410, and the side surface 430 may have an approximately rectangular plate shape having a height corresponding to a distance between the top surface 410 and the bottom surface 420.

Also, a first extension part 411 for guiding the wire 200 to be withdrawn may be provided on the top surface 410 of the terminal electrode 400, and a second extension part 412 for fixing one area of the wire 200 and providing the welding part 500 may be provided. That is, the first extension part 411 guides the withdrawal of the wire 200, and the second extension part 412 fixes the wire 200 disposed on the terminal electrode 400 and provides the welding part 500 with the wire 200. In other words, a portion of the wire 200 and the second extension part 412 may be melted to provide the welding part 500.

The first extension part 411 may be provided on one side, which faces the other side, of the top surface 410 contacting the side surface 430 of the terminal electrode 400. That is, the first extension part 411 may be provided on the second side facing the first side contacting the side surface 430 of the top surface 410. Also, the first extension part 411 may be provided adjacent to the stepped portion between the first and second areas 310 and 320 of the flange 300. That is, the first extension part 411 may have a predetermined depth from the corner area between the second and third sides to the second side. The above-described first extension part 411 may extend a predetermined height from the second side. That is, the first extension part 411 may be provided with a predetermined height from the top surface 410 to have the same depth. Alternatively, the first extension part 411 may be provided vertically from the top surface 410 or rounded to have a predetermined curvature toward the core 100. That is, the first extension part 411 may have a lower portion contacting the second side of the top surface 410 and an upper portion heading to an opposite direction of the core 100, and an area between the lower and upper portions may have a predetermined curvature to protrude toward the core 100. Here, the first extension part 411 may serve as a guide when the wire 200 is withdrawn and may not be bent. Surely, the first extension part 411 may have the same shape as that of the first extension part 411 described in accordance with an exemplary embodiment and another exemplary embodiment. That is, the first extension part 411 may include a height portion having a predetermined height from the top surface 410 and a horizontal portion extending from the end of the height portion to a direction opposite to the first area 310 of the flange 300, i.e., a direction toward the fourth side of the top surface 410. Accordingly, the first extension part 411 may have a ¬-shape in the fourth side direction or bent in the withdrawal direction of the wire 200, i.e., a direction opposite to the core 100, to temporarily fix the wire 200.

The second extension part 412 may be spaced apart from the first extension part 411. For example, the second extension part 412 may be provided on the third side of the top surface 410 of the terminal electrode 400 contacting the stepped portion of the flange 300. That is, the second extension part 412 may include a height portion provided with a predetermined height upward from a predetermined area of the third side and a horizontal portion provided with a predetermined size from an end of the height portion. Here, the horizontal portion may have a depth greater than that of the height portion. Also, the horizontal portion of the second extension part 412 may have an end having a U shape, and the height portion and the horizontal portion may be provided to have an approximately F shape. That is, the horizontal portion may have a groove provided in an area through which the wire 200 passes in a direction facing the core 100 and be provided to have an approximate U shape to provide a protruding portion on both sides of the groove. Here, the protruding portion disposed on both sides of the groove may extend to the outside of the terminal electrode 400. That is, the portion protruding with the U shape may extend until the area outside the side surface 430 of the terminal electrode 400 by assuming when the side surface 430 of the terminal electrode 400 vertically extends. The above-described second extension part 412 may be bent in a direction from the third side to the fourth side. Accordingly, in the second extension part 412, the wire 200 passes the groove in the U shaped portion and the protruding portion disposed on both sides thereof passes to extend to the outside of the side surface 430. As described above, the wire 200 may contact and be fixed on the top surface 410 of the terminal electrode 400 by the second extension part 412. Also, since the protruding portion of the second extension part 412 protrudes to the outside of the side surface 430 of the terminal electrode 400, the protruding portion of the terminal electrode 400 and the wire 200 may be bonded by the laser welding, and the wire 200 disposed above the terminal electrode 400 may not be uncovered to prevent excessive welding.

Meanwhile, as illustrated in FIG. 5, the opening 413 may be defined in the top surface 410 of the terminal electrode 400. Also, as illustrated in FIGS. 6 and 7, the protruding portion 421 may be provided on the bottom surface 420 of the terminal electrode 400, and, accordingly, as illustrated in FIG. 7, the stepped portion 330 may be provided on the bottom surface of the second area 320 of the flange 300. That is, in accordance with yet another exemplary embodiment, the opening and the stepped portion may be provided in the terminal electrode 400 as described in accordance with an exemplary embodiment and another exemplary embodiment.

The welding part 500 is provided on the upper portion of the terminal electrode 400 coupled to the second area 320 of the flange 300. The welding part 500 may be provided in such a manner that the laser is irradiated to the second extension part 412 in a state in which the wire 200 is fixed on the terminal electrode 400 by the second extension part 412 and the end thereof is disposed outside the terminal electrode 400. That is, as the laser is irradiated on the U shaped portion of the second extension part 412 in a state in which the wire 200 extends outside the terminal electrode 400, the end of the wire 200 may be melted to form a drop, and the wire 200 and the second extension part 412 are melted on the second extension part 412 to provide the welding part 500. Accordingly, the insulation layer provided by the insulation sheath may remain on the wire 200 below the welding part 500 to divide the welding part 500, the wire 200, and the terminal electrode 400 from each other. That is, the insulation layer may remain between the wire 200 below the welding part 500 and the terminal electrode 400 and between the welding part 500 and the wire 200. Also, the insulation layer may remain on a surface of the welding part 500 or the like. Meanwhile, the welding par 500 may be provided with a height less than that of the first area 310 of the flange 300, and thus the welding part 500 may not contact the cover 600.

The cover 600 may be provided above the core 100 around which the wire 200 is wound and to which the terminal electrode 400 is coupled, and have an approximately rectangular plate shape having a predetermined thickness.

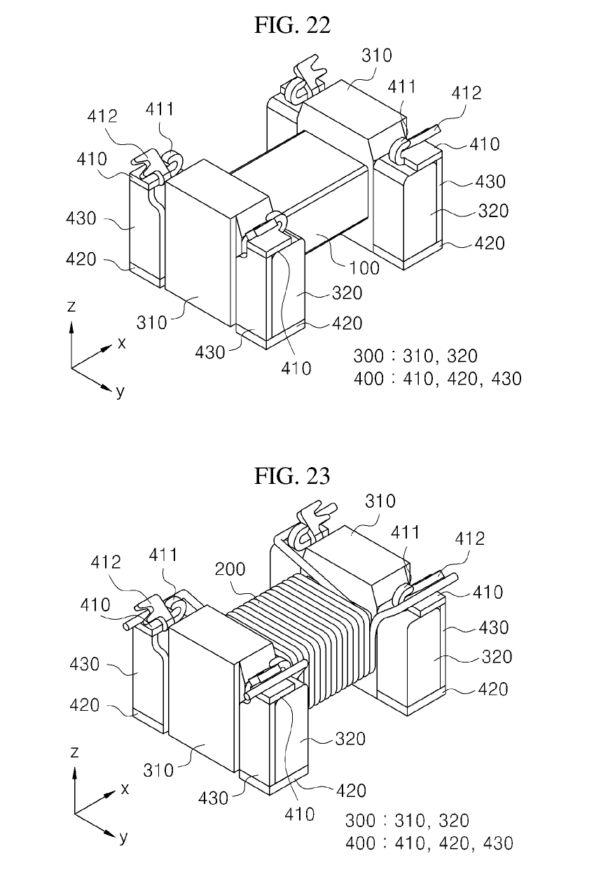

FIGS. 22 to 27 are perspective views for explaining a method for manufacturing the choke coil in accordance with yet another exemplary embodiment. FIG. 28 is a view illustrating the welding part and a cross-sectional image therebelow of the choke coil manufactured in accordance with yet another exemplary embodiment. Contents regarding the method for manufacturing the choke coil in accordance with yet another exemplary embodiment, which are different from those regarding the method of manufacturing the choke coil in accordance with an exemplary embodiment, will be mainly described.

Referring to FIG. 22, the core 100 in which the flanges 300 are respectively coupled to both ends thereof, and the cover 600 and the terminal electrode 400 is separately manufactured. Thereafter, the terminal electrode 400 is inserted into the second area 320 of the flange 300 to couple the terminal electrode 400 to the flange 300.

Referring to FIG. 23, the wire 200 is wound to surround the core 100. That is, the wire 200 may surround the core 100 from one side to the other side of the core 100 in the X direction. The above-described wire 200 may include the first wire wound to contact the core 100 and the second wire wound to contact the first wire. Both ends of the first wire may extend to the upper portion of the terminal electrode 400 coupled to the two flanges 300 facing each other, and both ends of the second wire may extend to the upper portion, to which the first wire does not extend, of the terminal electrode 400 coupled to the two flanges 300 facing each other. Here, the wire 200 may be guided to be withdrawn by the first extension part 411 formed on the top surface 410 of the terminal electrode 400. Also, the wire 200 may be deviated from the terminal electrode 400 to extend to be withdrawn outside the side surface 430 of the terminal electrode 400. That is, the end of the wire 200 may be disposed outside the terminal electrode 400. Here, according to a length of the wire deviated from the terminal electrode 400 and disposed outside the terminal electrode 400, a size or the like of the welding part 500 may be adjusted. For example, the welding part 500 may have a length of one time to five times of a diameter of the wire 200. That is, the length of the wire 200 extending from an area perpendicular to the side surface 430 of the terminal electrode 400 to the outside may be one time to five times of the diameter of the wire 200. When the length deviated outside the terminal electrode 400 is less than the above-described range, since the size of the welding part 500 is small or the welding part 500 is not formed, a bonding area between the wire 200 and the terminal electrode 400 may be less than the cross-section of the wire 200, and when greater than the above-described range, as the size of the welding part 500 increases, the height of the welding part 500 may be higher than that of the first area 310 of the flange 300 or the wire 200 may remain even after the welding part 500 is formed.

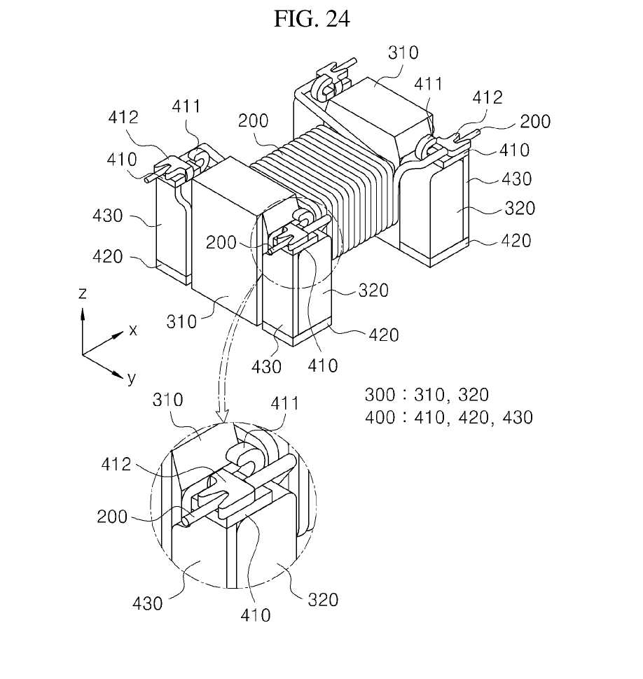

Referring to FIG. 24, the wire 200 is withdrawn, and then the second extension part 412 is bent to fix the wire 200. Thereafter, at least a portion of the sheath of the end of the wire 200, i.e., the area deviated outside the terminal electrode 400, is removed. For example, the laser is irradiated from the upper side to remove the upper side sheath of the wire 200, or the laser is irradiated from the lower side to remove the lower side sheath of the wire 200. That is, the sheath disposed on the area to which the laser is irradiated from the upper side or the area to which the laser is irradiated from the lower side is removed. Surely, the laser is irradiated two times from the upper and lower sides to completely remove the sheath of the wire 200. Meanwhile, when the laser is irradiated from the upper side, the sheath of the wire 200 on the U shaped portion of the second extension part 412, i.e., the area exposed by a recessed portion, may be removed.

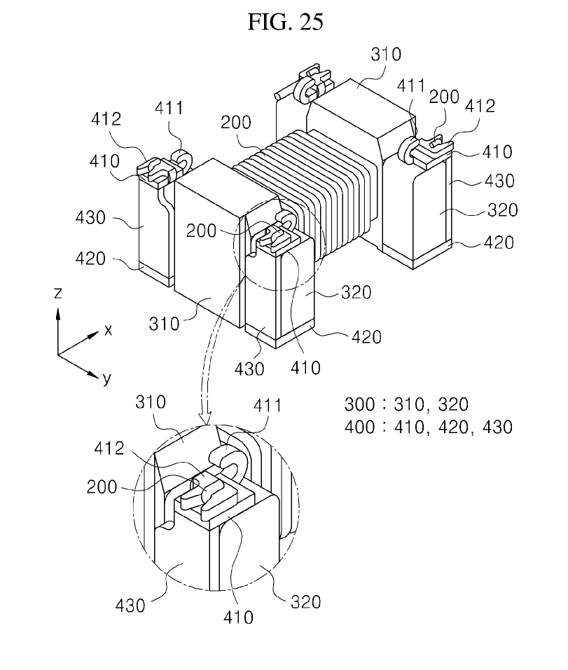

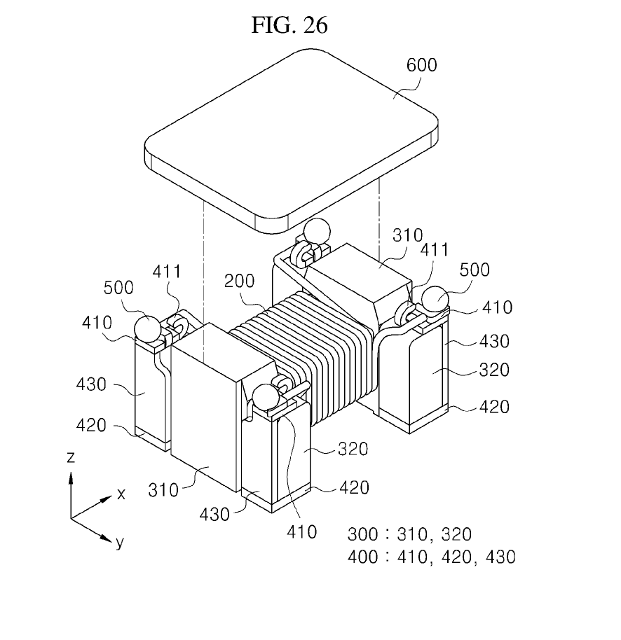

Referring to FIG. 25, the wire 200 withdrawn outside the terminal electrode 400 and from which the sheath is removed is bent upward from the second extension part 412. That is, in a state in which the wire 200 is withdrawn to the outside as illustrated in FIG. 24, the welding part 500 may be formed by irradiating the laser as illustrated in FIG. 26. Alternatively, as illustrated in FIG. 25, the wire 200 may be upwardly bent, and then the welding part 500 may be formed.

Referring to FIG. 26, the laser is irradiated toward the second extension part 412 to form the welding part 500. That is, the second extension part 412 and the wire 200 are melted by the laser irradiation to form the welding part 500 having a spherical shape on the top surface 410 of the terminal electrode 400. Here, the laser may be irradiated to a focal point on the area on which the U shaped second extension part 412 is formed. Here, as illustrated in FIG. 24, when the wire 200 is withdrawn outside the terminal electrode 400, the end of the wire 200 disposed outside the terminal electrode 400 is melted to form a drop, and the second extension part 412 and the wire are melted on the second extension part 412 to form the welding part 500. Also, as illustrated in FIG. 25, when the wire 200 is bent upward from the terminal electrode 400 and then the laser is irradiated, the wire disposed on the second extension part 412 is melted to disperse heat directly to the terminal electrode 400, thereby rapidly performing fusion of the terminal electrode 400. As a result, as heat caused by the laser may be divided to the wire 200 and the terminal electrode 500, stable welding is possible. The welding part 500 and the cross-section therebelow, which are formed as described above, are illustrated in FIG. 28. As illustrated in FIG. 28, the end of the wire 200 is melted together with the second extension part 412 of the terminal electrode 400 to form the welding part 500, and an insulation layer A remains between the welding part 500 and the terminal electrode 400. That is, since the wire 200 from which the insulation sheath is not removed remains between the welding part 500 and the terminal electrode 400, the insulation layer A remains. In other words, since the sheath of the wire 200 disposed below the second extension part 412 is not uncovered, a portion of the sheath may remain even after the welding part 500 is formed by the laser irradiation.

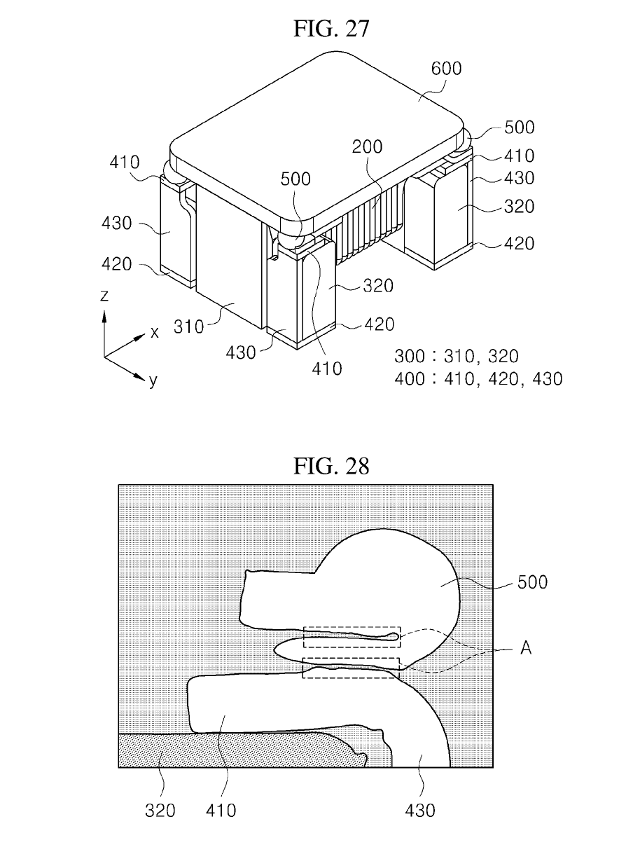

Referring to FIG. 27, the cover 600 is covered to contact the upper portion of the first area 310 of the flange 300.

In the choke coil in accordance with the exemplary embodiments, the flange is provided on each of the both ends of the core around which the wire is wound, and the terminal electrode having, e.g., the [symbol] -shape is coupled to the second area of the flange. Also, the inclined surface (or rounded surface) may be provided between the top surface and the front and rear surfaces of the second area of the flange to allow the terminal electrode to be easily coupled and prevent the wire withdrawn to the top surface of the terminal electrode from being disconnected. Accordingly, the assembly property may be improved, and the productivity and the quality may be also improved.

Also, as the opening is defined in the top surface of the terminal electrode, the energy of the laser irradiated to form the welding part may be restrained from being conducted to the top surface of the terminal electrode through the wire. Accordingly, the top surface of the terminal electrode may be prevented from being deformed by the heat generated during the laser irradiation, the welding part may be formed by using the optimized energy, and the thermal energy conducted to the wound wire may be reduced to prevent the disconnection.

Also, the stepped portion may be provided on the bottom surface of the second area of the flange to which the terminal electrode is coupled, and, in correspondence to the stepped portion, the protruding portion may be provided to closely couple the protruding portion to the stepped portion, thereby further firmly coupling the terminal electrode to the flange. Thus, the terminal electrode and the flange may be prevented from being separated from each other even by the vibration in the X, Y, and Z directions of the vehicle to which the choke coil is mounted.

Meanwhile, as the insulation layer formed by the insulation sheath of the wire may remain between the welding part and the wire disposed therebelow and between the wire and the terminal electrode threrebelow, the excessive welding may be prevented.

As described above, the technical idea of the present invention has been specifically described with respect to the above embodiments, but it should be noted that the foregoing embodiments are provided only for illustration while not limiting the present invention. Various embodiments may be provided to allow those skilled in the art to understand the scope of the preset invention, but the present invention is not limited thereto.

1. A choke coil comprising:
a core on which a flange is provided on each of both ends thereof;
a terminal electrode coupled to a portion of the flange;
a wire wound around the core and of which an end is withdrawn to an upper side of the terminal electrode; and
a welding part provided on an upper portion of the terminal electrode,
wherein the terminal electrode comprises top and bottom surfaces vertically facing each other and a side surface provided on one side between the top and bottom surfaces, and
the flange has inclined areas on between first and second surfaces respectively corresponding to the top and side surfaces of the terminal electrode and between the third surface facing the second surface and the first surface.

2. The choke coil of claim 1, further comprising an opening defined in the top surface of the terminal electrode and above which the wire is disposed.

3. The choke coil of claim 2, wherein the opening has a width greater than that of the wire and a length less than that of the wire seated on the top surface.

4. The choke coil of claim 1, further comprising a protruding portion provided on the bottom surface of the terminal electrode and a stepped portion provided on a bottom surface of the flange,
wherein the protruding portion is engaged with the stepped portion.

5. The choke coil of claim 1, further comprising an insulation layer provided on at least one area between the welding part and the terminal electrode.

6. The choke coil of claim 1, further comprising first and second extension parts spaced apart from each other on the top surface of the terminal electrode,
wherein the second extension part has a shape of which an area, through which the wire passes, is recessed, and an outer side convexly protrudes.

7. A choke coil comprising:
a core on which a flange is provided on each of both ends thereof;
a terminal electrode coupled to a portion of the flange;
first and second extension parts spaced apart from each other on one surface of the terminal electrode;
a wire wound around the core and of which an end is withdrawn to an upper side of the terminal electrode;
a welding part provided on the second extension part of the terminal electrode; and
an insulation layer provided on at least one area between the welding part and the terminal electrode.

8. The choke coil of claim 7, further comprising an opening defined in a top surface of the terminal electrode and above which the wire is disposed,
wherein the opening has a width greater than that of the wire and a length less than that of the wire seated on the top surface.

9. The choke coil of claim 7, wherein the flange has inclined areas on between first and second surfaces respectively corresponding to the top and side surfaces of the terminal electrode and between the third surface facing the second surface and the first surface.

10. The choke coil of claim 7, wherein the second extension part has a shape of which an area, through which the wire passes, is recessed, and an outer side convexly protrudes.

11. The choke coil of claim 7, wherein the wire comprises a conductive line and an insulation sheath configured to surround the conductive line, and the insulation layer is provided by the insulation sheath.

12. The choke coil of claim 7, further comprising a protruding portion provided on a bottom surface of the terminal electrode and a stepped portion provided on a bottom surface of the flange,
wherein the protruding portion is engaged with the stepped portion.

13. The choke coil of claim 1, wherein the flange comprises a first area contacting the core and a second area to which the terminal electrode is coupled, and the first area is provided higher than the second area.

14. The choke coil of claim 13, wherein a length from the side surface to the top surface of the terminal electrode is less than that from the side surface to the bottom surface of the terminal electrode.

15. The choke coil of claim 14, wherein the top surface of the terminal electrode has a rectangular plate shape of which a first side is connected to the side surface, and a second side disposed on one side of the first side comes into contact between the first and second areas of the flange.

16. The choke coil of claim 15, wherein the first extension part guides the withdrawal of the wire or temporarily fixes the wire, and the second extension part is bent in one direction to fix the wire and form the welding part.

17. The choke coil of claim 16, wherein each of the inclined areas has a width of 0.05 mm to 0.25 mm.

18. The choke coil of claim 17, wherein a distance between the inclined area and the top surface of the terminal electrode ranges from 0.05 mm to 0.25 mm.

19. (canceled)

20. (canceled)

21. (canceled)

22. (canceled)

23. (canceled)

24. (canceled)
